(19) United States
(12) Patent Application Publication
(10) Pub. No.: US 2025/0096263 A1
(43) Pub. Date: Mar. 20, 2025

(54) METHOD OF PREPARING GRAPHENE-BASED ZINC SINGLE ATOM CATALYST FOR ELECTROCATALYSIS IN LITHUM OXYGEN BATTERIES

(71) Applicant: THE HONG KONG UNIVERSITY OF SCIENCE AND TECHNOLOGY, HONG KONG (CN)

(72) Inventors: ZHENGTANG LUO, HONG KONG (CN); HOI LUN WONG, HONG KONG (CN)

(21) Appl. No.: 18/466,836

(22) Filed: Sep. 14, 2023

(51) Int. Cl. H01M 4/583; H01M 4/04; H01M 10/052; H01M 10/0568; H01M 10/0569

(52) U.S. Cl. CPC H01M 4/583; H01M 4/0404; H01M 10/052; H01M 10/0568; H01M 10/0569; H01M 2300/0028

(57) ABSTRACT

Single atom catalysts (SACs) are efficient electrocatalysts for catalyzing the oxygen reduction reaction (ORR) and oxygen evolution reaction (OER) in lithium-oxygen batteries (LOBs). Our method is to study the origin of reactivity for a series of 17 transition metals supported on nitrogen-doped graphene, denoted SACs using Quantum Mechanics methods. Based on Gibbs free energy calculations, Zn-SAC performs the highest electrochemical activity among 17 SACs investigated. Machine learning (ML) is developed an intrinsic descriptor Φ, that correlates the catalytic activity with electronic and chemical properties of the catalytic centers at the M-N₄ active site on graphene surface. A linear relationship between Φ and the catalytic activity that provides guidance for designing efficient SACs for electrocatalysis in LOBs. Zn-SAC is synthesized through chemical vapor deposition (CVD) process, which shows more stable cyclability and exhibits smaller reaction overpotentials, verifying the simulation results.

### TECHNICAL FIELD

The present technology is generally related to electroactive materials and battery using such electroactive materials exhibiting ultra-stable cyclic life, and high columbic efficiency, and a method of preparing the electroactive materials, in particular to a method of preparing a graphene-based zinc single atom catalyst (Zn-SAC) and an electrochemical whole battery and an electrochemical symmetric battery using the same.

### BACKGROUND

To support the development of electric vehicles (EVs), rechargeable lithium-oxygen batteries (LOBs) have stimulated great attention in the research for high energy storage due to the numerous advantages of ultrahigh theoretical energy density (3600 Wh kg⁻¹) and more abundant and cheap raw materials of oxygen. The typical aprotic LOBs are comprised of lithium metal anode, separator, Li ionic conducting electrolyte and the perforated carbon cathode with catalyst coating. As for the working principles of LOBs, O₂ is first adsorbed at the catalyst surface, then reduced to superoxide (O₂⁻), react with Lit to form lithium superoxide (LiO₂), followed by the further reduction with another Li⁺ to lithium peroxide (Li₂O₂), which is oxygen reduction reaction (ORR) during battery discharge. The reverse process is the oxygen evolution reaction (OER) during battery charge.

However, the sluggish kinetics of ORR/OER owing to the chemical inertness of O₂ and poor electrical conductivity of Li₂O₂ lead to poor cyclability, low round-trip efficiency and inferior rate capability, hindering its application and commercialization. To date, extensive strategies have been proposed to tackle the problem by introducing efficient catalyst to reduce the reaction activation energy and boost the reaction kinetics, such as, carbonaceous materials, noble metals, metal alloys and transition metal oxides and sulfides. These catalyst face shortcoming of high cost and active site passivation by insulating Li₂O₂.

### SUMMARY

In one aspect, a method of preparing a zinc single atom catalyst (Zn-SAC) material with graphene support composite active materials is provided, where the method includes the annealing via chemical vapor deposition (CVD) process. And confinement of Zn²⁺ ions by the electrostatic interactions between the functional groups from graphene oxide (GO) and Zn²⁺. The details are shown below:
S1: The GO was prepared by the modified Hummers method that graphite powder was first expended by microwave and added with various oxygen-containing functional group by wet chemical method. After adding the functional groups, the graphite interlayer was separated and soluble in water. Then, GO is diluted to 5 mg mL⁻¹ by adding deionized (DI) water;
S2: Accurate amount of 20 μL of 0.05 M Zn²⁺ solution and 100 μL of acrylamides were added into the GO solution, which was stirred for 24 hours to ensure a uniform dispersion. The mixed solution was frozen rapidly and then freeze-dried for 24 hours;
S3: The brownish dried sample was annealed at 750° C. for 1 hour under 200 sccm Ar gas to produce Zn-SAC;
S4: Acid treatment was done to leach out the extra metal loading by putting powder samples in the acid solution and heated at 80° C. for 24 hours. Then, the sample was washed by water using centrifuge, freeze dried and heated at 750° C. for 1 hour, where the Zn-SAC is for the testing in LOBs.

In another aspect, lithium oxygen battery includes a lithium anode, a separator, electrolyte and cathode materials, wherein: cathode was prepared by casting the slurry, containing 90% of Zn-SAC composite, 10% of binder in the solvent of alcohol, cast on carbon paper. The electrolyte is 1 M LiTFSI/TEGDME. The separator is glass fiber. All the components are assembled into 2023-type coin cell in Ar-filled glove box to avoid O₂ and H₂O contamination. Before battery testing, it was kept in the container purged with ultra-pure O₂. The galvanostatic discharge-charge tests were conducted using CT2001A LAND battery tester.

### BRIEF DESCRIPTION OF THE DRAWINGS

FIG. 1 demonstrates the synthesis process of graphene-based Zn-SAC.

FIG. 2A shows the low-resolution STEM image of Zn-SAC.

FIG. 2B exhibits the high-resolution STEM Images of Zn-SAC.

FIG. 2C is the zoom-in STEM image of Zn-SAC at high-magnification that indicates the single atom distribution.

FIG. 2D exhibits the EDS mapping of Zn-SAC.

FIG. 3 is a representative X-ray diffraction pattern of graphene-based Zn-SAC.

FIG. 4A illustrates the full X-ray photoelectron spectroscopy (XPS) spectrum of Zn-SAC.

FIG. 4B illustrates N 1s spectrum with three types of nitrogen doping of graphene.

FIG. 4C illustrates Zn 2p spectrum.

FIG. 5A shows the normalized metal K-edge X-ray absorption near-edge structure (XANES) spectra for Zn-SAC.

FIG. 5B shows the corresponding Fourier transform (FT) magnitudes of EXAFS spectra in R space of Zn-SAC.

FIG. 6 is a schematic illustration of a typical LOBs battery configuration model based on Zn-SAC cathode.

FIG. 7 is the discharge-charge curve of nitrogen-doped graphene (NG) at a current density of 0.05 mA cm⁻² and areal capacity of 0.1 mAh cm⁻² for 1-50^{th} cycle.

FIG. 8 is the discharge-charge curve of Mo-SAC at a current density of 0.05 mA cm⁻² and areal capacity of 0.1 mAh cm⁻² for 1-50^{th} cycle.

FIG. 9 is the discharge-charge curve of Zn-SAC at a current density of 0.05 mA cm⁻² and areal capacity of 0.1 mAh cm⁻² for 1-50^{th} cycle.

FIG. 10A is the cycling performance of NG, Mo-SAC and Zn-SAC at 1^{st} cycle.

FIG. 10B is the cycling performance of NG, Mo-SAC and Zn-SAC at 50^{th} cycle.

### DESCRIPTION OF EMBODIMENTS

Various embodiments are described below. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

Herein, we report a novel material, 2D graphene-based zinc single atom catalyst (Zn-SAC), functioning as the catalyst at the cathode to increase the rate of oxygen reduction reaction (ORR) and oxygen evolution reaction (OER) in lithium oxygen batteries (LOBs). The synthesis process of Zn-SAC includes the chemical vapor deposition (CVD), below is the details for the synthesis process:
S1: Preparing graphene oxide (GO) using the modified Hummers method, chemically separate the graphite layer by inserting functional groups, and then disperse the GO into deionized (DI) water to obtain the diluted GO solution;
S2: Adding accurate amount of 20 μL of 0.05 M Zn²⁺ and 100 μL of acrylamide into the GO solution, the mixed solution was stirred for 24 hours to ensure the uniform dispersion of ions on GO surface. After the stirring process, the mixture was frozen rapidly and then freeze-dried for 24 hours;
S3: After the freeze drying, the brownish dried sample was annealed at 750° C. for 1 hour under 200 sccm Ar to produce Zn-SAC.
S4: Acid leaching was carried out to remove extra metal loading by immersing the Zn-SAC powder sample into the acid solution and heated at 80° C. for 24 hours. The sample was then washed by water under centrifugation, followed by freeze drying and another heating at 750° C. for 1 hour, where the as-synthesized Zn-SAC is then tested in LOBs.

With the Zn-SAC at carbon cathode, it provides catalytic active sites for the electrocatalysis and increases the reaction rate for ORR/OER conversion, exhibiting lower overpotential. From the electrochemical tests of discharge-charge profile, Zn-SAC exhibits an ultra-stable cyclability with reduced overpotentials compared to the reference samples of molybdenum single atom catalyst (Mo-SAC) and nitrogen doped carbon (NG).

As provided in more detail below, Zn-SAC cathode was prepared by coating the Zn-SAC slurry on carbon paper. By introducing single atom catalyst, O₂ is reduced with Li and reacted at the active site forming LiO₂. The weaker interaction between LiO₂ and Zn-SAC surface promotes the disproportionation reaction that large Li₂O₂ toroid are more likely generated rather than large thin-film. Besides, the weak adsorption of LiO₂ makes the further reduction easier, leading to smaller reaction overpotentials, which is favorable for the battery's lifespan.

The Zn-SAC coated cathode was assembled with lithium metal anode, glass fiber separator and Li ion containing electrolyte, run in coin-typed battery, which exhibits prolong cycling life and stability.

### EMBODIMENTS

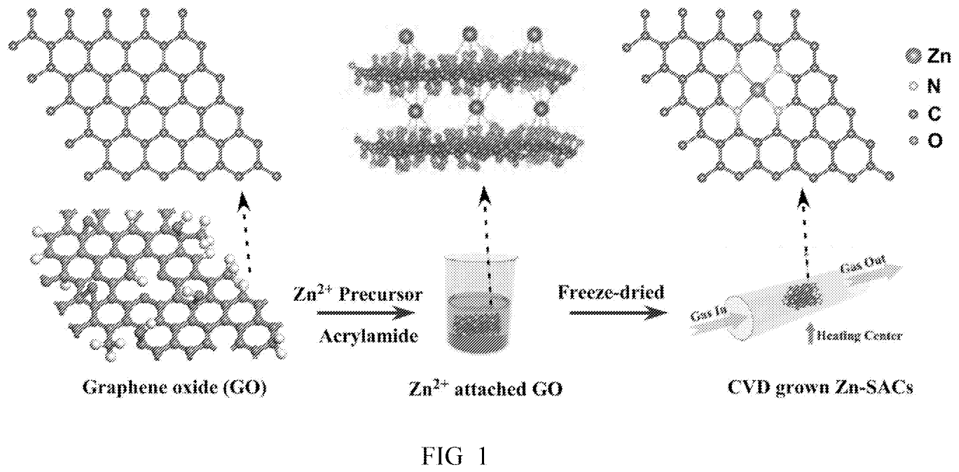

Embodiment 1. A cathode catalyst synthesis technique. The preparation process of zinc single atom catalyst with graphene support is illustrated in FIG. 1. The graphene oxide (GO) was prepared by a modified Hummers method and dispersed into 100 ml of the deionized (DI) water. Then, 20 μL of 0.05 M ZnCl₂·6H₂O and 100 μL were added into the GO solution, followed by sonification for 2 hours and vigorous stirring for 24 hours to ensure a good mix. The mixed solution was frozen rapidly and then freeze-dried for another 24 hours. The dried sample was annealed in the chemical vapor deposition (CVD) furnace at 750° C. for 1 hour under 200 sccm Ar gas to produce Zn-SAC. All chemicals with analytical grade were purchased from Sigma-Aldrich without further treatment and the deionized (DI) water was used throughout the whole experiment.

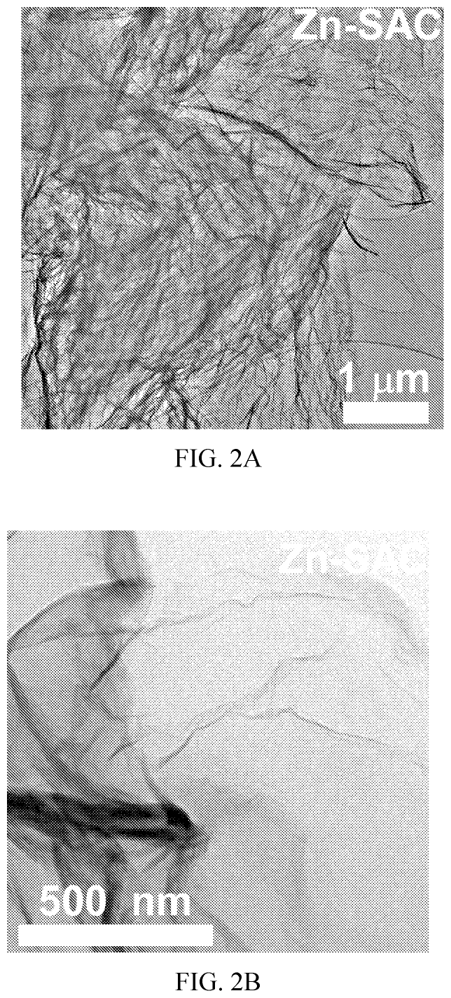

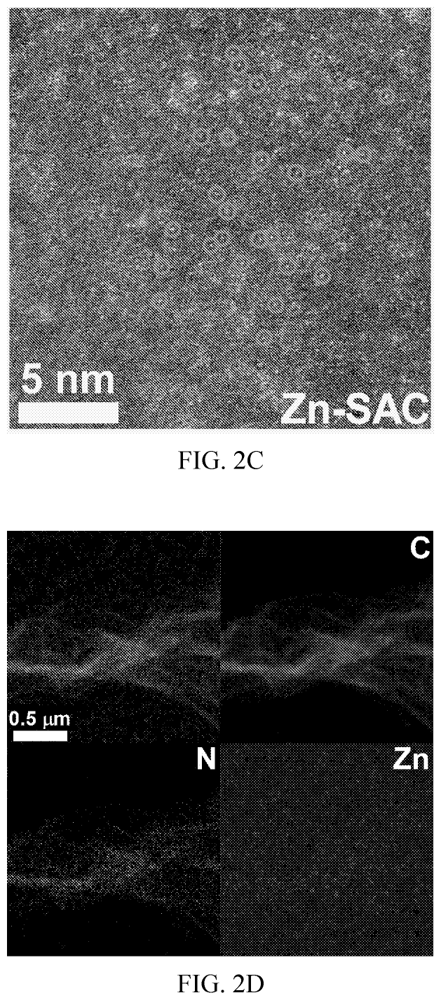

The morphology and atomic structure of Zn-SAC were characterized using HRTEM with EDS mapping. The low-magnification STEM image of Zn-SAC in FIG. 2A indicates clean 2D structure of ultrathin graphene substrate. The higher-resolution images in FIG. 2B clearly shows that no nanoparticles and impurities are observed in the single atom catalyst composite. In addition, uniform distribution of the atomically isolated Zn atoms on the whole graphene nanosheet was observed in FIG. 2C. Furthermore, the energy dispersive analysis (EDS) shown in FIG. 2D confirms the existence of carbon, nitrogen, and zinc, which can be found in the mapping results.

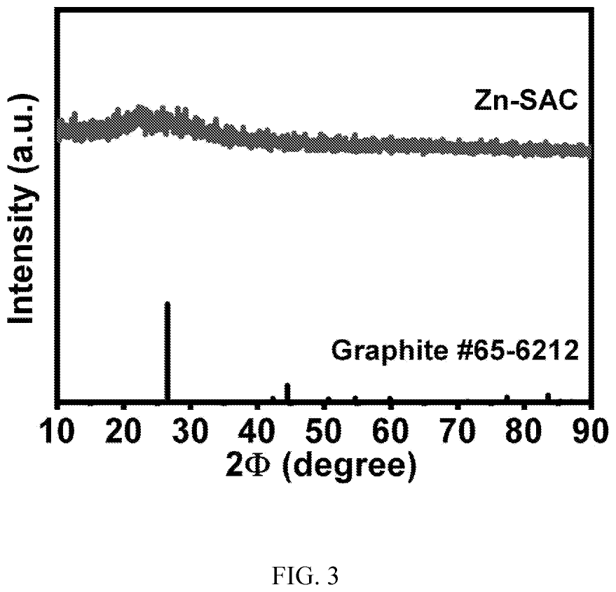

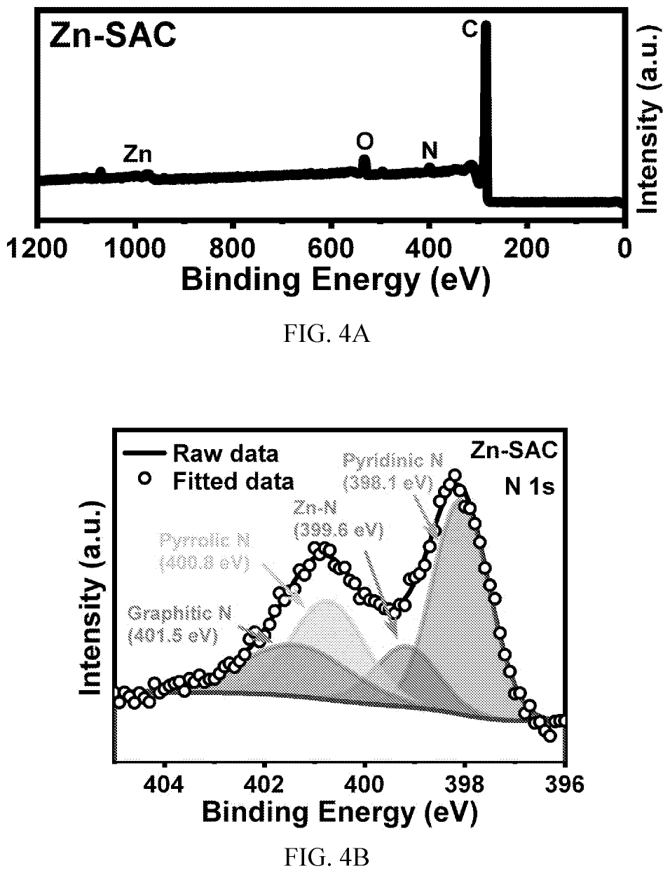

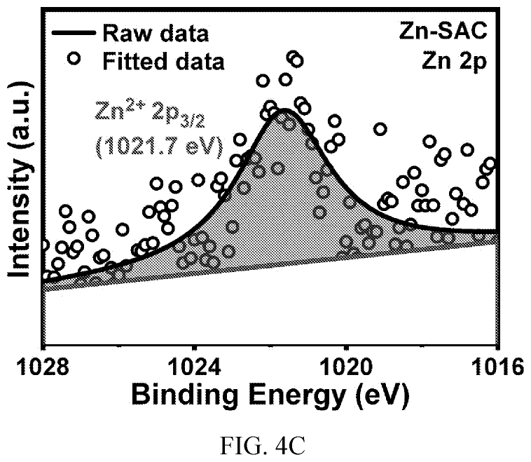

FIG. 3 illustrates the crystal structure of Zn-SAC, where only a diffraction peak at 23.0° corresponds to the (002) lattice plane of reduced graphene oxide. And FIG. 4A, the full XPS spectrum shows the elemental composition of Zn, N, C, and O in the sample of Zn-SAC. The high-resolution N 1s spectrum (FIG. 4B) identifies three types of nitrogen doping at binding energies of 398.1. 400.8 and 401.5 eV, corresponding to pyridinic N, pyrrolic N, and graphitic N, respectively. Moreover, the peak at 399.6 eV represents the Zn—N bond structure. The Zn 2p spectrum in FIG. 4C identifies a peak at 1021.7 eV, attributed to Zn²⁺ 2p _{3/2} electronic states.

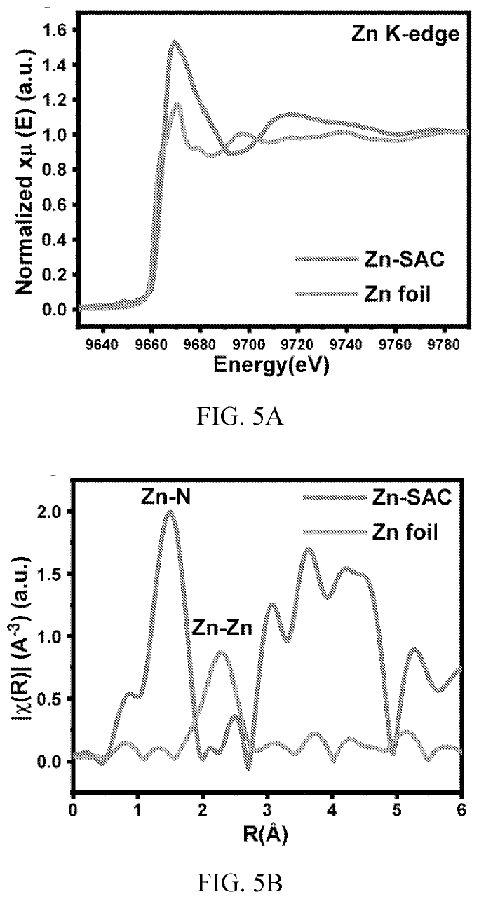

The Zn K-edge XANES in FIG. 5A shows that the x-ray absorption edge position of Zn-SAC is significantly different from Zn foil, indicating that the valence state of Zn in Zn-SAC is different from Zn (0) in the bulk Zn phrase. The EXAFS Fourier transform for Zn-SAC in FIG. 5B verifies the coordination of Zn with N. More specifically, FT-EXAFS of Zn-SAC shows a major peak at 1.49 Å, attributed to the Zn—N peak, while a distinct peak at 2.29 Å belonging to Zn—Zn bonds were present.

Embodiment 2. A preparation method of Zn-SAC cathode for lithium-oxygen batteries. The as-synthesized Zn-SAC was mixed with polymer binder in the solvent of alcohol (9:1, mass ratio), becoming slurry cast onto the carbon paper, which was dried in a vacuum oven at 60° C. for 24 h.

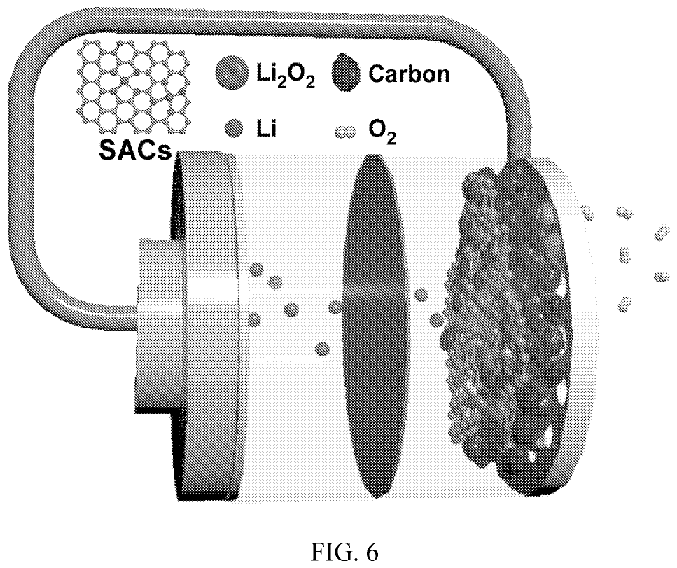

Embodiment 3. Assembly of a coin-typed battery. As shown in FIG. 6, 2023 coin-cells were assembled using one lithium foils (99.9%, Sigma-Aldrich Corporation) as the anode, Zn-SAC cathode, 100 μL as electrolyte of (1 M LiTFSI/TEGDME) and glass fiber separator in Ar-filled glove box to avoid O₂ and H₂O contamination. Before the measurement, the assembled batteries were kept in the container purged with ultra-pure O₂.

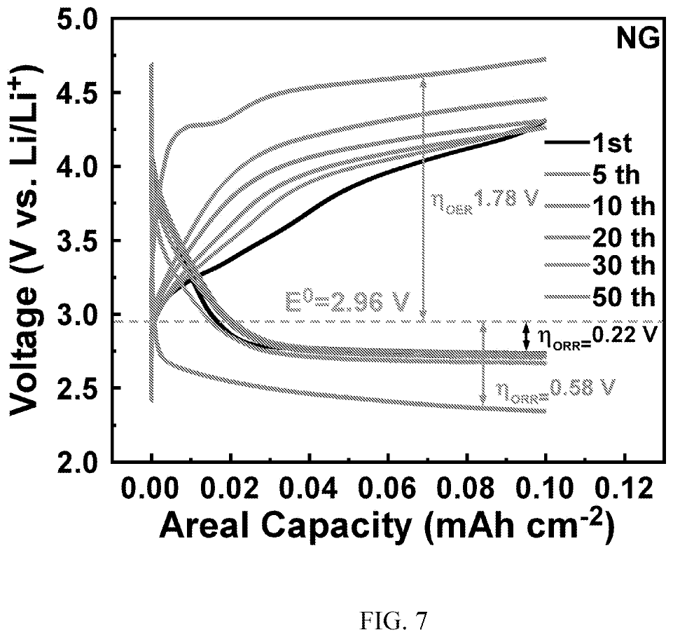

FIG. 7 shows the discharge capacity of nitrogen-doped graphene (NG) from 1^{st} to 50^{th} cycles with the capacity of 0.1 mAh cm⁻² at current density of 0.05 mA cm⁻², exhibits the highest ORR overpotential of 0.22 V at first discharge cycle and increased along the cycling and reached 0.58 V after 50 cycles, accounting for 174% increase from the 1^{st} cycle. In the charging process, NG delivered a high OER overpotential of 1.32 V.

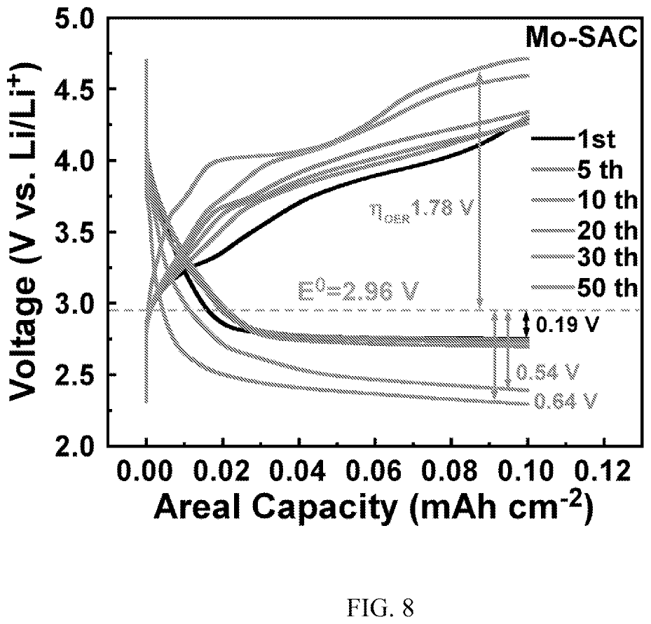

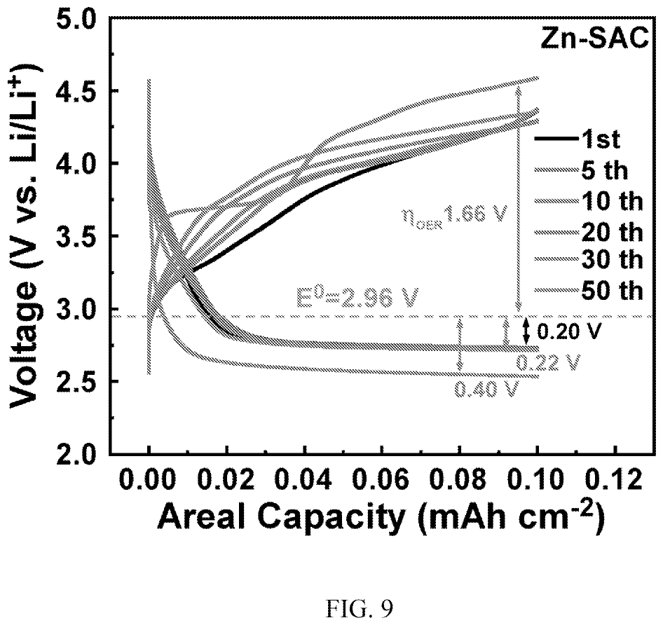

In comparison, Mo-SAC delivered a slightly reduced ORR overpotential of 0.19 V at first discharge cycle (FIG. 8), which dramatically increased to 0.64 V after 50 cycles, accounting for 232.4% change from the 1^{st} cycle. In the OER process, Mo-SAC has 1.34 V reaction overpotential at 1^{st} cycle and increased to 1.78 V after 50 cycles. In sharp contrast, Zn-SAC exhibited a stable cyclability (FIG. 9) that achieved an ORR overpotential of 0.20 V at the beginning and retained the overpotentials of 0.22 and 0.40 V after 30 and 50 cycles, respectively. During the charge process, Zn-SAC exhibited the lowest OER overpotential of 1.66 V after cycling, compared to the samples of NG and Mo-SAC.

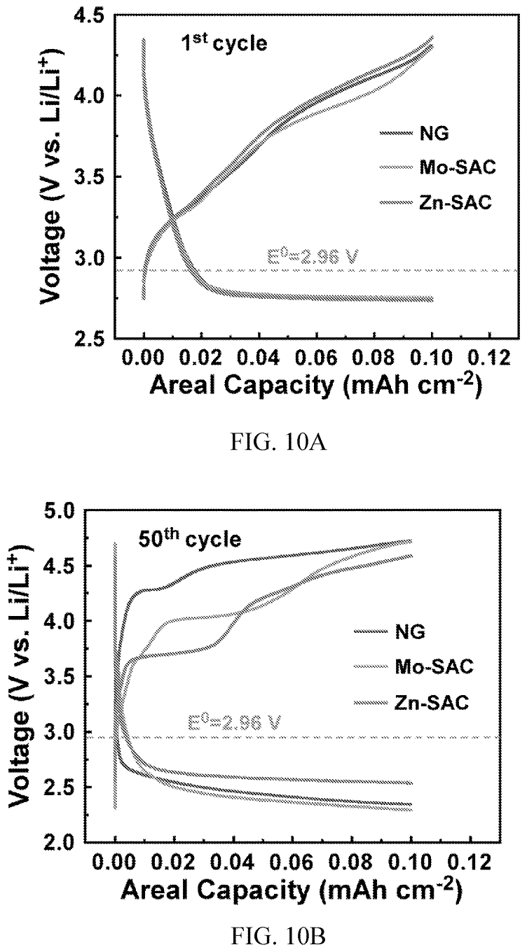

FIG. 10 shows the stability of Zn-SAC in ORR/OER process. On the first cycle (FIG. 10A) a flat discharge plateau at 0.2 V was observed for Zn-SAC, Mo-SAC and NG. After 50 cycles (FIG. 10B), Zn-SAC showed the best performance, retaining 0.4 discharge overpotential, proving the role of Zn-SAC in catalyzing the ORR/OER process in LOBs.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure

What is claimed is:

1. A method of preparing a graphene-based zinc single atom catalyst, comprising:
preparing graphene oxide (GO) by a modified Hummers method and dispersing the 2 mL of 5 mg mL⁻¹ GO in 30 ml of deionized (DI) water to obtain GO solution; then sonicate the GO solution for 2 hours. 20 μL of 0.05 M Zn²⁺ solution from ZnCl₂·6H₂O and 100 μL of acrylamides, as nitrogen precursors, were added into the diluted GO suspension and stirred for 24 h. The solution mixture was then frozen rapidly, followed by freeze drying to obtain a brownish dried sample; annealing the dried sample at 750° C. for 1 hour under 200 sccm Ar gas to produce Zn-SAC. Acid treatment was performed to leach out the extra metal loading from Zn-SAC at 80° C. for 24 hours, followed by DI water washing, freeze drying and heating at 750° C. for 1 hour.

2. A lithium oxygen battery, comprising:
a lithium anode;
a Zn-SAC coated on a carbon paper cathode;
a glass fiber as a separator; and
the organic electrolyte of 1 M LiTFSI/TEGDME;
wherein the battery is kept in the container purged with ultra-pure O₂.

3. The lithium oxygen battery of claim 2, wherein the cathode of Zn-SAC on carbon paper is constructed with zinc single atom catalyst with graphene support coated on a carbon paper; 90% catalytic Zn-SAC layer with graphene support is a powder and then mixed with 10% binder, then alcohol solvent is added and stirred together to obtain a uniform slurry to coat on a carbon paper.

4. The lithium oxygen battery of claim 2, wherein the separator is glass fiber with a thickness of 420 μm, a diameter of the separator is about 19 mm.

5. The lithium oxygen battery of claim 2, the electrolyte is composed of 1 M LiTFSI/TEGDME.
